(19) United States
(12) Patent Application Publication
(10) Pub. No.: US 2025/0136846 A1
(43) Pub. Date: May 1, 2025

(54) LASER PRINTABLE, FLEXIBLE DRUM LABELS

(71) Applicant: Avery Dennison Corporation, Mentor, OH (US)

(72) Inventors: Yijun YE, Solon, OH (US); Ajay S. DESAI, Concord Township, OH (US)

(21) Appl. No.: 18/835,443

(22) PCT Filed: Mar. 17, 2023
(86) PCT No.: PCT/US2023/064610

§ 371 Date: Aug. 2, 2024

Related U.S. Application Data
(60) Provisional application No. 63/320,795, filed on Mar. 17, 2022.

(51) Int. Cl. C09J 7/29; B65D 25/20; C09J 7/38; C09J 7/40; G09F 3/02; G09F 3/10

(52) U.S. Cl. CPC C09J 7/29; B65D 25/205; C09J 7/385; C09J 7/405; G09F 3/02; G09F 3/10; C09J 2203/334; C09J 2301/41; C09J 2301/416; G09F 2003/0201; G09F 2003/0226; G09F 2003/0255; G09F 2003/0257; G09F 2003/0272

(57) ABSTRACT

Laser printable, flexible drum labels that are sufficiently durable for marine environments are disclosed. Drums containing the durable labels are also disclosed.

### CROSS-REFERENCE TO RELATED APPLICATION(S)

The present application claims the benefit of U.S. Provisional Patent Application No. 63/320,795 filed Mar. 17, 2022, which is incorporated herein by reference in its entirety.

### FIELD OF THE INVENTION

The present invention generally relates to printable labels. More particularly, the invention relates to laser printable, flexible drum labels that are sufficiently durable for marine environments.

### BACKGROUND OF THE INVENTION

Thermoplastic polyvinyl chloride (PVC) films with pressure-sensitive adhesives have been widely used in both indoor and outdoor labeling applications, such as for consumer and industrial products, although other polymeric films are also useful. They are often used in applications requiring conformability and printability. Unfortunately, PVC-based formulations often result in fogging, and release hydrogen chloride (HCl) when they burn. The released HCl fumes, and the breakdown of the HCl fumes, may pose a health hazard. Furthermore, to achieve the soft, conformable characteristics of flexible polyvinyl chloride, a current practice is to formulate with phthalates, which are associated with potential health risks. In addition, it is also unfortunate that PVC production typically requires a vinyl chloride starting material. The vinyl chloride production, as well as incineration of waste PVC, may create harmful dioxins. Accordingly, label constructions are needed that have characteristics of PVC-based formulations, yet lack PVC and its inherent disadvantages.

One use of PVC labels has been to durably mark dangerous goods packages for carriage by sea. “Durably marked” has been defined to mean that the label or other marking is such as to remain identifiable on packages that have been in the sea for a period of at least three months. Experience has shown that labels manufactured, for example, in accordance with British Standard BS5609, result in the production of a printed label that is capable, when properly applied, of providing the required durable marking.

No current offerings seem to address the need for a label construction that has the conformability and print durability of PVC, without the inclusion of PVC, and that is suitable for use as drum labels in harsh environments, such as marine environments. Further, there is a need for such label constructions that can pass British Standard BS5609 testing. Conventional polyolefin based synthetic films contain high weight percentages (e.g. around 60 weight percent) of nonabrasive filler, and accordingly, such films are highly porous, due to their high filler loading, resulting in a very thick (e.g. greater than 6 mil) and expensive film. The label constructions of the present invention are directed toward resolving these deficiencies, and other important ends.

### SUMMARY OF THE INVENTION

The invention relates generally to printable, flexible drum labels that are durable, especially for marine environments and the drums labeled therewith. The label constructions of the invention, which preferably contain low topcoat coatweights (such as for example, less than 10 gsm, preferably less than 5 gsm), pass the British Standard BS5609 test, preferably, without causing curl and static. The label constructions of the invention are also flexible, which permits them to be conformable and perform effectively as drum labels.

Accordingly, one aspect of the invention is directed to label constructions, including: a facestock with a first surface and a second surface; wherein the facestock includes a laminate including: at least one film layer including: a first polymer having a melting point; wherein the first polymer is selected from the group of a polypropylene polymer, polypropylene copolymer, and a combination thereof; and at least one of an opacifying agent and a cavitating agent; and at least one non-woven layer including a second polymer; wherein the second polymer has a melting point at least 5° C. greater than the melting point of the first polymer; and a topcoat applied to at least a portion of the first surface of the facestock; and an adhesive layer with a first surface and a second surface; wherein the first surface of the adhesive layer is applied to at least a portion of the second surface of the facestock; and an optional release liner layer applied to at least a portion of the second surface of the adhesive layer.

Another aspect of the invention is directed to storage drums, including: a container; wherein the container is formed from a material selected from the group of plastic, metal, cellulose fiber, and combinations thereof; and a label including: the label construction of described herein; and a laser-printed indicia applied to the topcoat.

The summary of the invention is provided as a general introduction to some of the embodiments of the invention, and is not intended to be limiting. Additional example embodiments, including variations and alternative configurations, of the invention are provided herein.

### BRIEF DESCRIPTION OF THE DRAWINGS

The accompanying drawings, which are included to provide a further understanding of the invention and are incorporated in and constitute a part of this specification, illustrate embodiments of the invention, and together with the description, serve to explain the principles of the invention. In the drawings:

FIG. 1 illustrates an exemplary embodiment of a label construction as described herein, including a facestock layer, topcoat, adhesive layer, and an optional release liner layer.

FIG. 2 illustrates an exemplary embodiment of a facestock layer of a label construction as described herein, including a film layer and two nonwoven layers.

FIG. 3 is a graphical representation of results of stress relaxation testing of label constructions according to the invention, and comparative films.

None of the figures are drawn to scale.

### DETAILED DESCRIPTION OF THE ILLUSTRATED EMBODIMENTS

### Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended as open-ended, and cover a non-exclusive inclusion. For example, a process, method, article, or apparatus that comprises a list of elements is not necessarily limited to only those elements, but may include other elements not expressly listed or inherent to such process, method, article, or apparatus. Also, use of “a” or “an” is employed to describe elements and components described herein. This is done merely for convenience and to give a general sense of the scope of the invention. This description should be read to include “one” or “at least one” and the singular also includes the plural, unless it is obvious that it is meant otherwise by the context.

As used herein, the term “about,” when referring to a measurable value such as an amount, a temporal duration, and the like, is meant to encompass variations of ±10%, preferably, ±8%, more preferably, ±5%, even more preferably, ±1%, and yet even more preferably, ±0.1% from the specified value, as such variations are appropriate to perform the disclosed methods.

As used herein, “pressure sensitive adhesive” or “PSA” refers to a material that may be identified by the Dahlquist criterion, which defines a pressure sensitive adhesive as an adhesive having a one second creep compliance of greater than 1×10⁻⁶ cm²/dyne as described in Handbook of PSA Technology, Donatas Satas (Ed.), 2^{nd} Edition, page 172, Van Nostrand Reinhold, New York, N.Y., 1989. Since modulus is, to a first approximation, the inverse of creep compliance, pressure sensitive adhesives may also be defined as adhesives having a Young's modulus of less than 1×10⁶ dynes/cm². Another well-known means of identifying a pressure sensitive adhesive is an adhesive that it is aggressively and permanently tacky at room temperature, and firmly adheres to a variety of dissimilar surfaces upon mere contact, without the need of more than finger or hand pressure, and which may be removed from smooth surfaces without leaving a residue, as described in Glossary of Terms Used in the Pressure Sensitive Tape Industry provided by the Pressure Sensitive Tape Council, 1996. Another suitable definition of a suitable pressure sensitive adhesive is that it preferably has a room temperature storage modulus within the area defined by the following points, as plotted on a graph of modulus versus frequency at 25° C.: a range of moduli from about 2×10⁵ to 4×10⁵ dynes/cm² at a frequency of about 0.1 radians/sec (0.017 Hz), and a range of moduli from about 2×10⁶ to 8×10⁶ dynes/cm² at a frequency of approximately 100 radians/sec (17 Hz). See, for example, Handbook of PSA Technology (Donatas Satas, Ed.), 2^{nd} Edition, page 173, Van Nostrand Rheinhold, N.Y., 1989. Any of these methods of identifying a pressure sensitive adhesive may be used to identify suitable pressure sensitive adhesives for use in the constructions of the invention.

As used herein, the term “film” refers to an object that has one dimension (thickness) that is relatively small compared to the other two dimension (length and width). The length and width of a film are typically each 1 cm or greater. The surface of a film defined by its length and width is known herein as the “face” of the film.

As used herein, the prefix “(meth)acryl-” refers to both “methacryl-” and “acryl-”, such as in “(meth)acrylic” (meaning both methacrylic and acrylic), “(meth)acrylate” (meaning both methacrylate and acrylate), and “(meth)acrylonitrile” (meaning both methacrylonitrile and acrylonitrile). The term “(meth)acrylate” refers to monomeric acrylic or methacrylic esters of alcohols. Acrylate and methacrylate monomers are referred to collectively herein as “(meth)acrylate” monomers. Polymers prepared from (meth)acrylate monomers are referred to as (meth)acrylate polymers.

As used herein, the term “acrylic polymer” refers to at least one (meth)acrylate polymer or copolymer and may include a blend of different (meth)acrylate polymers and copolymers.

As used herein, the term “polymer” will be understood to include polymers, copolymers (e.g., polymers formed using two or more different monomers), oligomers, and combinations thereof.

The term “copolymer” is used herein to refer to polymers containing copolymerized units of at least two different monomers (e.g. a dipolymer).

As used herein, the term “adhesive layer” means a layer or multiple layers of the same or different pressure sensitive adhesives applied to at least a portion of the first face of the facestock layer of the invention.

As used herein, the term “release liner” means film sheet (typically paper or polymeric film, usually applied during the manufacturing process) used to prevent a sticky surface from prematurely adhering. It is coated on one or both sides with a release agent, which provides a release effect against any type of a sticky material, such as an adhesive or a mastic.

As used herein, the term “printed indicia” means any string of alphanumeric or special characters used to convey information (such as name, residence or mailing address, telephone number, prescription number, and the like) and/or provide aesthetic appeal. The indicia may be printed by any suitable means including printing by hand, typewriter, or conventional printing (such as flexographic printing, offset printing, inkjet printing, laser inkjet printing, videojet printing, thermal transfer, direct printing, gravure printing, and the like).

As used herein, the abbreviation “gsm” means grams per square meter.

As used herein, the expression “biaxially oriented polypropylene” or “BOPP” means a film or laminate that has been stretched in both the machine direction (MD), and cross (CD) or traverse direction (TD).

As used herein, the “conformable” means a film or laminate capable of substantially conforming to an underlying surface to which it is applied, so that the exposed surface of the conformable film mimics the topology of the underlying surface. In contrast, a non-conformable film, i.e. a film which does not have sufficient flexibility, may not follow the contour of the subject or surface to which it is applied, creating bubbles or gaps between the surface and the film. A high tensile modulus may make the film hard to apply over a surface, e.g. those surfaces that have curves, angles, ridges and other non-planar configurations, but too low a modulus may result in deformation of the film and potentially causing a distortion of the printed indicia. Films with a high relaxation stress may cause the film to delaminate over time, when the film has been applied to a non-planar surface.

As used herein, the term “durable” means the ability of a label construction to withstand the harsh environmental, or use conditions, as measured by the print key and sand abrasion tests of British Standard BS5609 (1986) for printed pressure-sensitive, adhesive-coated labels for marine use.

As used herein, the term “layflat” means the ability of a label construction to lay flat without curling, in accordance with at least one of the layflat at different humidities testing, or the layflat after laser printing testing, as described in the Examples section.

As used herein, the term “laser-printable” means a film or label construction capable of being printed on by laser printing technology, using at least black and red ink.

All percentages noted herein are percentages by weight based upon the weight of the composition, unless indicated otherwise.

The invention relates generally to laser printable, flexible drum label constructions that are durable, especially in harsh environments, such as for example marine environments where the labels may be exposed to salt water (including marine immersion), sand, UV light, and the like. The labels maintain their dimensional stability and colorfastness, thus remaining readable on packages that have been in the sea for long periods of time, such as for example, at least three months. Thus, the labels advantageously can be used to identify the contents of drums that have been lost at sea for long periods of time. The labels are suitable for application to any drum. In some embodiments, the labels are suitable for use on drums containing dangerous materials, such as for example, chemical drums containing hazardous materials. In some embodiments, the label constructions pass the tests of British Standard BS5609 (1986). In some embodiments, the label constructions pass the tests of British Standard BS5609 (1986) Section 2, related to marine immersion, dimensional stability and color fastness of printed pressure-sensitive adhesive-coated labels for marine use. In some embodiments, the label constructions pass the tests of British Standard BS5609 (1986) Section 3, related to print key effectiveness, abrasion and permanence of printed pressure-sensitive, adhesive-coated labels for marine use. In some embodiments, the label constructions pass at least one of Section 2 and Section 3 of British Standard BS5609 (1986).

The invention will be described in further detail with respect to the label constructions, as well as the drums labeled therewith. The label constructions include a facestock, a topcoat, and an adhesive layer. The facestock has a first surface and an oppositely directed second surface. The facestock may have any suitable thickness. In certain embodiments, the facestock has a total thickness of from 50 μm to 150 μm. In some embodiments, the facestock has a total thickness of from 75 μm to 140 μm, from 85 μm to 135 μm, from 95 μm to 130 μm, or from 100 μm to 125 μm.

The facestock includes a laminate. The laminate includes at least one film layer and at least one non-woven layer. The film layer includes a first polymer and an opacifying agent, or a cavitating agent, or both. In other words, the film layer includes at least one of an opacifying agent or a cavitatating agent. The first polymer may be any suitable polymer. In some embodiments the first polymer is at least one of a polypropylene polymer or polypropylene copolymer. In some embodiments the first polymer is at least one of a polypropylene polymer or polypropylene-polyethylene copolymer. In some embodiments the first polymer is a polypropylene polymer and a polypropylene-polyethylene copolymer. In certain embodiments, the first polymer is a polypropylene-polyethylene copolymer where the polyethylene is present in a minor amount, such as less than 35% by weight, based on the total weight of the first polymer. In certain embodiments, the first polymer is a polypropylene-polyethylene copolymer where the polyethylene is present in an amount, of less than 25% by weight, less than 20% by weight, less than 15% by weight, or less than 10% by weight, based on the total weight of the first polymer. The first polymer has any suitable melting point.

As noted hereinabove, the facestock film layer includes at least one of an opacifying agent or a clarifying agent. A variety of techniques are known to modify a polymer film and render it opaque. For example, an opaque polymer film can be produced by adding opacifying agents. The opacifying agent may be any suitable opacifying agent, such as for example, fillers and pigments, such as for example, titanium dioxide, calcium carbonate, talc, and the like. For oriented films, opacity can also be achieved by voiding or cavitation, for example by including at least one of organic or inorganic cavitating agents in one or more layers of the polymer film. In some embodiments, the film layer includes at least one cavitating agent. By “cavitating agent” is meant herein at least one particle that induces micro-voids in a material, thus rendering the material opaque. The presence of the cavitating agent in a layer of the film during the orientation of the film induces micro-voids. The voids scatter light, thereby causing the film to be opaque. With a high degree of voiding, the film density can be reduced accordingly. Any suitable cavitating agent can be used. In some embodiments, the cavitating agent is a void-initiating particle including at least one of an organic polymer or an inorganic material. In some embodiments, the cavitating agent is a void-initiating particle including an organic polymer, such as for example, a polyamide, (such as for example, nylon-6), a polyester (such as for example polybutylene terephthalate (PBT)), an acrylic resin, or combinations thereof. In some embodiments, the cavitating agent is a void-initiating particle including an organic polymer, such as for example cyclic olefin polymers, cyclic olefin copolymers, ethylene norbornene copolymers, or combinations thereof. In some embodiments, the cavitating agent is a void-initiating particle including an inorganic polymer, such as for example, a glass, metal, ceramic, silica, calcium carbonate (CaCO3), clay, talc, or combinations thereof. In some embodiments, at least a portion of the film layer is an oriented polypropylene (PP) film, and the cavitating agent is a beta-nucleating PP. In some embodiments, at least a portion of the film layer is a beta-crystalline form of polypropylene. In some embodiments, the conformable label constructions have an opacity of at least 95% as determined by Technical Association of the Pulp and Paper Industry (TAPPI) standard T-425. In some embodiments, the conformable label constructions have an opacity of at least 80%, at least 84%, at least 90%, at least 95%, or at least 98%, as determined by TAPPI standard T-425.

The film layer may be a single or mono-layer film, or a multi-layer film. In some embodiments, the film layer is a single or mono-layer film layer. In some embodiments, the film layer is a multi-layer film layer, including at least two layers. In some embodiments, each layer of the multi-layer film is the same. In some embodiments, at least two of the layers of the multi-layer film are different. In some embodiments, each layer of the multi-layer film is different.

The formation of films is well known to those of ordinary skill in the film forming art, and need not be discussed herein in detail. There are a large number of vendors who can manufacture such films to exacting specifications. Plastic films can be produced using either the blown film or cast film processes. Blown films, also commonly known as tubular films, are created by extruding plastic through a tubular-shaped die and then stretched and blown with air to create a very thin-walled film. In some embodiments, the film layer is formed using a coextrusion process. Coextrusion is used to produce films containing more than one plastic layer. In this method, two or more different plastic granules are heated and melted separately. The melts are taken together either before or at the die lips, so that the mixed plastics are extruded as a single product, namely a multilayer web of plastic film or sheet. The film layer may have any suitable thickness. In some embodiments, the film layer has a thickness of from 55 μm to 135 μm, from 60 μm to 130 μm, from 65 μm to 130 μm, from 75 μm to 125 μm, or from 80 μm to 120 μm.

Polymer films can be stretched or oriented to improve properties such as mechanical strength, dimensional stability, chemical resistance, and optical appearance. In some embodiments the film layer is oriented in one direction. Such mono-axially oriented films are typically oriented in the machine direction (MD). In some embodiments at least one film layer is oriented in the machine direction. In some embodiments the film layer is oriented in the machine direction. In some embodiments the laminate is oriented in the machine direction. Mono-axially oriented films can be stretched in an apparatus like a machine direction orienter (MDO) unit, such as is commercially available from the Marshall and Williams Company of Rhode Island, USA. A MDO unit has a plurality of stretching rollers that progressively stretch and thin the film in the machine direction, which is the direction of travel of the film through the apparatus. In some embodiments at least one film layer is biaxially oriented. In some embodiments the film layer is biaxially oriented. In some embodiments the laminae is biaxially oriented. Biaxially oriented films, such as BOPP, can be produced for example, by a tubular (blown) process, or a tenter frame process, which are well known in the art. In some embodiments at least one film layer is a blown film that is additionally oriented in the machine direction. In some embodiments the film layer is a blown film that is additionally oriented in the machine direction.

In certain embodiments of the label construction, the film layer is microporous. In some embodiments, the laminate is microporous. By “microporous” is meant herein having a higher degree of permeability than a solid film. In some embodiments, the micropores in the microporous film or laminate, or both, are induced by cavitation of the film layer by stretching. Suitable microporous films are commercially available, such as for example Aptra® films from RKW, SE (located in (Mannheim, Germany). In some embodiments, the microporous film or laminate, or both, is stretched or oriented to make the material more bendable.

As noted hereinabove, in addition to the film layer, the facestock laminate also includes at least one nonwoven layer. The presence of the nonwoven layer increases the flexibility of the label construction. In some embodiments, the non-woven layer has a thickness of from 8 μm to 16 μm. The non-woven layer includes a second polymer. Any suitable polymer may be used for the second polymer. In certain embodiments, the second polymer is a polypropylene homopolymer, a polypropylene copolymer, or both. In other words, in certain embodiments, the second polymer is at least one of a polypropylene homopolymer or a polypropylene copolymer. In certain embodiments, the second polymer is a polypropylene homopolymer, or a blend of a polypropylene (co)polymer and a polyethylene (co)polymer, or both. In other words, in certain embodiments, the second polymer is at least one of a polypropylene homopolymer, or a blend of a polypropylene (co)polymer and a polyethylene (co)polymer. As used herein, “(co)polymer” refers to both polymer and copolymer. The second polymer has a melting point that is at least 5° C. greater than the melting point of the first polymer. In some embodiments, the second polymer has a melting point at least 10° C. greater than the melting point of the first polymer. In some embodiments, the second polymer has a melting point at least 15° C., or at least 20° C., greater than the melting point of the first polymer.

The nonwoven layer may be formed by conventional methods. Suitable fibrous nonwoven web forming processes include, for example, spunbonding and meltblowing processes. In some embodiments, the non-woven material in the non-woven layer is made by a spunbonding or meltblowing process. Meltblown fibers are formed by extruding molten thermoplastic material through a plurality of fine usually circular die capillaries, as molten threads or filaments, into a high velocity, usually heated, gas stream, such as air, which attenuates the filaments of molten thermoplastic material to reduce their diameters. Thereafter, the meltblown fibers are carried by the high velocity, usually heated, gas stream, and are deposited on a collecting surface to form a web of randomly dispersed meltblown fibers. The meltblown process is well-known and is described in patents such as U.S. Pat. Nos. 3,676,242 and 3,849,241, both of which are incorporated herein by reference in their entirety. Spunbond fibers are formed by extruding a molten thermoplastic material as filaments from a plurality of fine, usually circular, capillaries in a spinneret, with the diameter of the extruded filaments then being rapidly reduced, for example, by non-eductive or eductive fluid-drawing, or other well-known spunbonding mechanisms. The production of spunbond nonwoven webs is illustrated in patents such as U.S. Pat. Nos. 4,340,563, 3,802,817, 3,692,618, 3,338,992, 3,341,394, 3,276,944, 3,502,538, 3,502,763, and 3,542,615, all of which are incorporated herein by reference in their entirety.

Fibrous nonwoven webs made from multiconstituent and multicomponent fibers such as, for example, bicomponent fibers, can also be used to form the nonwoven layer. See, for example, U.S. Pat. No. 5,336,552, which is incorporated herein by reference in its entirety, and which describes how to make bicomponent spunbond nonwoven webs. In some embodiments, the nonwoven layer is a non-woven web. It is also possible to form laminates for use as the nonwoven layer such as spunbond/meltblown laminates and spunbond/meltblown/spunbond laminates, as are taught, for example, in U.S. Pat. No. 4,041,203, which is incorporated herein by reference in its entirety. In some embodiments, the nonwoven layer is a non-woven laminate. In some embodiments, the nonwoven layer is a non-woven laminate including at least one of a spunbond non-woven or a meltdown nonwoven. In some embodiments, the nonwoven layer includes at least one of a spunbond/meltblown laminate or a spunbond/meltblown/spunbond laminate.

Once the film layer has been formed, and optionally stretched or oriented, as described hereinabove, it is laminated to the nonwoven layer. The lamination may be performed by any suitable means, such as for example, by adhesives, ultrasonic bonding, thermal lamination, and thermomechanical bonding such as through the use of heated calendering rolls. Such calendering rolls may include a patterned roll and a smooth anvil roll, though both rolls may be patterned or smooth. One, both or none of the rolls may be heated. In some embodiments, the lamination is performed by a thermal lamination method, where a film layer is produced by heating the film up to the molten state and combining the film with the nonwoven (which has a melting point sufficiently above the crystallite melting point of the film) and by then guiding the composite through a cooled nip, such as described in U.S. Pat. Nos. 7,947,147 B2 and 10,221,166 B2, which are incorporated herein by reference in their entirety. In preferred embodiments, the starting film web may be stretched prior to lamination with the starting nonwoven web or composite containing the film, and the nonwoven may be stretched, such as described in U.S. Pat. Nos. 7,947,147 B2 and 10,221,166 B2.

In certain embodiments of the label construction, the film layer is oriented in both the MD and CD directions after the film is cast or blown. In certain embodiments of the label construction, the laminate is oriented in both the MD and CD directions. In certain embodiments of the label construction, after the film layer(s) and nonwoven layer(s) are laminated together, the laminate is oriented in a biaxial direction.

In some embodiments, the laminate includes two non-woven layers, with one film layer located between the two non-woven layers.

In certain embodiments, the facestock is corona treated on one or both sides. The corona treatment improves anchorage of at least one of the ink, topcoat, and/or adhesive as the case may be. By “anchorage” is meant herein the bonding strength between the facestock, or the film layer of the facetock, and the ink, topcoat, and/or adhesive.

As noted hereinabove, in addition to the facestock, the label construction also includes a topcoat and an adhesive layer. The topcoat is applied to at least a portion of the first surface of the facestock. In some embodiments, the topcoat is applied to the entire first surface of the facestock. In some embodiments, the topcoat is applied to substantially the entire first surface of the facestock. The topcoat may be applied to the facestock by any suitable means, such as for example, gravure coating. The topcoat may be applied to the facestock in any suitable amount. Conventional polyolefin labels typically need a high topcoat coat weight, such as 15 gsm. Meanwhile conventional PET films can be used with low topcoat coatweights, due to their higher heat resistance, however such films are not as flexible. The present label construction is flexible, and also enables the use of a lower coat weight than is typically found in conventional polyolefin labels for laser printing. In certain embodiments, the topcoat coat weight is lower than the coat weight needed for conventional labels to withstand laser printing, without experiencing curl or jam caused by film shrinkage or deformation due to the heat. In certain embodiments, the topcoat coat weight is lower than the coat weight needed for conventional labels to pass British Standard BS5609. In certain embodiments, the coatweight level of the topcoat is less than 10 gsm. In some embodiments, the coating level of the topcoat is less than 8 gsm, less than 7 gsm, less than 6 gsm, or less than 5 gsm. The topcoat can be made of any suitable material, such as for example, an acrylic polymer, a urethane acrylic polymer, or combinations thereof. In certain embodiments, the topcoat includes an acrylic polymer.

The adhesive layer has a first surface and a second surface. The first surface of the adhesive layer is applied to at least a portion of the second surface of the facestock. In some embodiments, the adhesive layer is applied to the entire second surface of the facestock. In some embodiments, the adhesive layer is applied to substantially the entire second surface of the facestock. The adhesive may be applied to the facestock in any suitable amount. In certain embodiments, the label constructions include an adhesive layer that is present at a coatweight level of from 15 gsm to 27 gsm. In some embodiments the adhesive layer that is present at a level of from 18 gsm to 26 gsm, or from 20 gsm to 25 gsm. The adhesive can be made of any suitable material, such as for example, an acrylic polymer. In some embodiments, the adhesive includes a tackifier. In certain embodiments, the acrylic polymer is produced by emulsion polymerization, solvent polymerization, or polymerization by UV exposure. Examples of suitable acrylic emulsion polymers include those having a good performance on low surface energy substrates, showing excellent UV weathering and salt water exposure performance, and having good low temperature adhesive properties, such as for example acrylic emulsion polymers commercially available from Avery Dennison Corporation (located in Ohio, USA). In certain embodiments, the acrylic polymer is produced by solvent polymerization or 100% solids polymerization. In some embodiments, the acrylic polymer has a high tack to low surface energy substrates. In certain embodiments, the adhesive is a hot melt adhesive.

In certain embodiments, the label constructions further include a release liner layer applied to at least a portion of the second surface of the adhesive layer. In some embodiments, the release liner layer is applied to the entire second surface of the adhesive layer. In some embodiments, the release liner layer is applied to substantially the entire second surface of the adhesive layer. In certain embodiments, the release liner layer includes a polycoated kraft paper (PCK), or PET film liner. In certain embodiment, the release liner layer includes a clay-coated kraft paper (CCK).

As previously noted, no conventional labels seem to address the need for a label construction that has the conformability and print durability of PVC, without the inclusion of PVC for use as drum labels in harsh environments, such as marine environments. The present label constructions are flexible enough to be used as a replacement for PVC films, without the health, safety and sustainability issues associated with PVC films. The flexibility of the label constructions enable the label constructions to be applied on drums having a variety of different shapes and configurations. In some embodiments, the label constructions are 3-dimensional conformable films.

The conformability of a film can be measured in different ways, such as stress relaxation, load at hold, residual stress, or L&W (Lorentzen & Wettre) bending, as described the examples herein-below. In some embodiments, the conformable label constructions exhibit a stress relaxation of at least 35% in both the MD and CD directions. In some embodiments, the conformable label constructions exhibit a stress relaxation of at least 40% in both MD and CD direction. In some embodiments, the conformable label constructions exhibit a load at hold of less than 10 lb/in (1750 N/m) in both MD/CD directions. In some embodiments, the conformable label constructions exhibit a load at hold of at least one of from 4 to 8 lb/in (700 to 1400 N/m) in the MD direction or less than 10 lb/in (1750 N/m) in the CD direction. In some embodiments, the conformable label constructions exhibit a load at hold of at least one of from 5 to 7 lb/in 880 to 1230 N/m) in the MD direction or less than 10 lb/in (1750 N/m) in the CD direction.

L&W (Lorentzen & Wettre) bending tests (also known as the Technical Association of the Pulp and Paper Industry (TAPPI) standard T-556) can be used to determine the bending resistance of a film, by measuring the force required to bend a specimen under controlled conditions. In some embodiments, the conformable label constructions exhibit a L&W bending of at least 14 mN in both the MD and CD directions, as determined by the following L&W bending test: cut samples measuring 50.8 mm×38.1 mm are clamped by a 38 mm wide clamp in the specimen holder on a bending tester, such as for example an ABB L&W tester (commercially available from ABB Ltd., located in Zurich, Switzerland), and then passed mechanically by a load cell to determine the amount of force (measured in mN) necessary to bend a 5 mm length of the sample at an angle of 15°. In some embodiments, the conformable label constructions exhibit an L&W bending of at least 14 mN, at least 25 mN, at least 40 mN, at least 50 mN in both the MD and CD directions, as determined by the above-specified L&W bending test. In some embodiments, the conformable label constructions exhibit an L&W bending in the MD of no more than 60 mN. In some embodiments, the conformable label constructions exhibit an L&W bending in the CD of no more than 90 mN.

Lower heat shrinkage of a film or construction advantageously reduces the curl of the film or construction, after laser printing. In some embodiments, the conformable label constructions exhibit a heat shrinkage, as measured by ASTM D1204 for 5 MIN at 130° C., of from 1% to 6% in the MD direction and from 2% to 15% in the CD direction. In some embodiments, the conformable label constructions exhibit a heat shrinkage, as measured by ASTM D1204 for 5 MIN at 130° C., of from 2% to 5% in the MD direction and from 3% to 10% in the CD direction.

In some embodiments, the conformable label constructions exhibit a layflat after laser printing of no more than 25.4 mm curl of each corner. In some embodiments, the conformable label constructions exhibit a layflat after laser printing by a British Standard BS5609 certified printer of no more than 25.4 mm curl of each corner. In some embodiments, the conformable label constructions exhibit a layflat at a relative humidity of 30% of no more than 25.4 mm curl of each corner. In some embodiments, the conformable label constructions exhibit a layflat at a relative humidity of 50% of no more than 25.4 mm curl of each corner. In some embodiments, the conformable label constructions exhibit a layflat at a relative humidity of 70% of no more than 25.4 mm curl of each corner. In some embodiments, the conformable label constructions exhibit a layflat of from 0″ (0 mm) to 2″ (50.8 mm). In some embodiments, the conformable label constructions exhibit a layflat of from 0″ (0 mm) to 1.5″ (38.1 mm). In some embodiments, the conformable label constructions exhibit a layflat of from 0″ (0 mm) to 1″ (25.4 mm).

Laser printing is an electrographic printing. A laser beam projects an image to be printed onto an electrically charged rotating drum coated with photoconductors. Photoconductivity allows charge to leak away from the areas exposed to light. Dry toner particles are then electrostatically picked up by the drum's charged areas, which have not been exposed to light. The drum then prints the image onto media by direct contact and heat, which fuses the ink to the media. The powder toner is composed of pigment particles and low melt polymer resins and can develop static-electrical charges easily. When printed labels exit a printer, they are typically charged. The static charge must dissipate quickly in order for the labels to be stacked neatly, and for the stack can be shuffled easily. High static charged labels can stick together. Static dissipation of the conformable label constructions enable continuous sheeting and printing. If the facestock surface resistance is too low, a good laser printing may not be achieved. Meanwhile, too high of a surface resistance may cause high static charge during sheeting, making it is not easy to stack the label constructions together. In some embodiments, the static dissipation of the constructions is achieved by a surface resistance of at least one of the facestock or the liner of from 1E8 to 1E13 ohm. In some embodiments, the static dissipation of the constructions is achieved by a surface resistance of at least one of the facestock or the liner of from 1E8 to 1E12, or from 1E9 to 1E10 ohm. In some embodiments, the static dissipation of the constructions is achieved by a surface resistance of both the facestock and the liner of from 1E8 to 1E13 ohm. In some embodiments, the static dissipation of the constructions is achieved by a surface resistance of both the facestock and the liner of from 1E8 to 1E12, or from 1E9 to 1E10 ohm.

In some embodiments, the conformable label constructions pass the printer jam test, whereby a sheet is fed into a laser printer and then the printer is manually stopped while the sheet is passing through the fuser roll; after a certain dwelling time (typically 20 s), the sheet is pulled out and inspected to determine whether it remains a continuous sheet with no stringing, when sheet was pulled out.

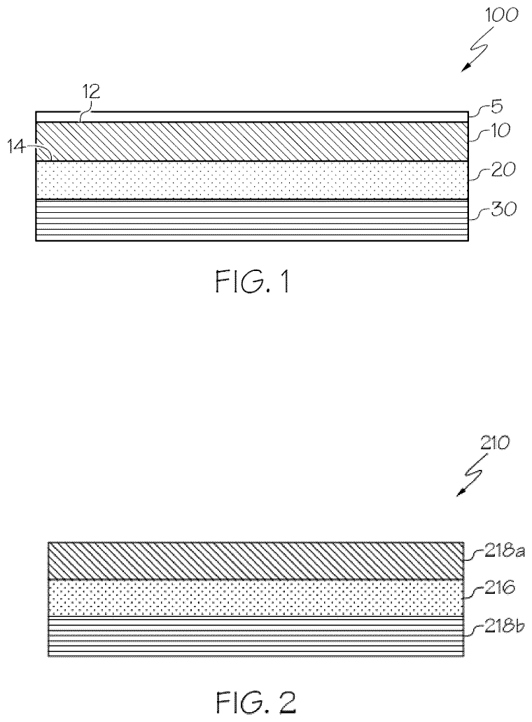

FIG. 1 illustrates a label construction as described herein. The article 100 includes a topcoat 5, a facestock layer 10, pressure sensitive adhesive layer 20, and optional release layer 30, as described herein (and not shown to scale). The facestock layer 10 defines a first side 12 and an oppositely directed second side 14. The facestock layer 10 is shown as a single layer, but may be multilayer. The pressure sensitive adhesive layer 20 is applied over at least a portion of the second side 14 of the facestock 10. The pressure sensitive adhesive layer 20 is shown as a single layer, but may be multilayer. The topcoat 5 is applied over at least a portion of the first side 12 of the facestock 10. Optional print indicia (not shown) may be applied to the topcoat layer 5 side of the label construction 100.

Referring to FIG. 2, the film/nonwoven laminate 210, which serves as the facestock layer in the label construction according to the present invention, includes a film layer 216 and two nonwoven layers 218a, 218b, wherein the film layer 216 is located between the two non-woven layers 218a, 218b.

The invention is also directed to storage drums on which are attached the label constructions as described hereinabove. The storage drums may be containers of any suitable type, such as for example, plastic (such as for example HDPE), metal (such as for example painted steel), cellulose fiber, and combinations thereof. In some embodiments, at least one indicia is applied to the label construction. In some embodiments, the at least one indicia is applied to the topcoat on the label construction facestock. In some embodiments, the at least one indicia is laser printed on the topcoat on the label construction facestock. Laser printing of the drum label requires special printing technology. Because it is difficult to pass the British Standard BS5609 test, there are only a few BS5609 certified printers available. A special combination of printer and toner are needed to pass BS5609, and suitable printers typically print at higher temperatures than normal office printers. Suitable commercial printers include, but are not limited to, printers sold under the brands of Lexmark C792e, Lexmark C6160 (commercially available from Lexmark International, Inc., located in Kentucky, USA); Primera CX1200 (commercially available from Primera Technology, Inc., located in Minneapolis, USA); NeuraLabel 500e, NeuraLabel 600e (commercially available from Neuralabel Printing Solutions, located in Texas, USA); Ricoh SP830, Ricoh 840 (commercially available from Ricoh Company, Ltd., located in Tokyo, Japan); Japan Electronics Ind. Inc JP 600-L, Japan Electronics Ind. Inc JP 621-LC (commercially available from Japan Electronics Ind. Inc, located in Japan).

The present invention is further defined in the following Examples, in which all parts and percentages are by weight, unless otherwise stated. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various usages and conditions.

### EXAMPLES

The following test methods were used to evaluate exemplary embodiments and comparative materials, unless otherwise noted.

### Print Durability Testing

Print durability is based on the Print Key/Anchorage Test, Abrasion Resistance Test, and Color Fastness set forth in Section 3 of British Standard Test BS5609 (1986) for printed pressure-sensitive, adhesive-coated labels for marine use.

For the Print Key/Anchorage, the test was run with 1-inch (2.54 cm) wide tape with a 15-second dwell at a 90° peel. Samples were evaluated to determine if no more than 5% ink was removed and color change was no more than 3.

For the Abrasion Resistance, the test samples were immersed for 24 hours with the printed label applied to a stainless steel rod in saline solution, which were exposed to 500 revolutions in a rod abrader vessel containing the water/sand mixture. The samples were evaluated to determine the legibility and identifiability of the text and symbols.

For the Color Fastness, test samples were exposed to five cycles of 17 hours UV light and 6 hours salt spray. The samples were evaluated to determine if the color fastness rating was greater than or equal to 2 (pass).

### Curl (Layflat) Testing

Layflat Standard Testing: This test was used to measure the amount of curl on a laminate sample.

Layflat at Different Humidities Testing: A test sample is a 8.5″×11″ (21.6×27.9 cm) sheet, with the long edge (11″; 27.9 cm) in the biaxial direction. Samples were subjected to three different humidity environments (30%, 50%, 70%). The distance the corners lifted from the rack was measured and recorded in inches. A set of samples was placed with one sheet face up and one sheet face down into a 30% relative humidity (RH) chamber and L-shaped measuring rulers on each corner. Another set of samples was placed with one sheet face up and one sheet face down into a 70% RH chamber and L-shaped measuring rulers on each corner. A third set of samples was placed with one sheet face up and one sheet face down onto a rack in the TAPPI Lab (at 50% RH). Results were recorded after a 1-hour dwell and/or other time periods (such as 15 minutes and curl of each corner less than 25.4 mm, 38.1 mm and 50.8 mm).

Layflat after laser printing: The Layflat Standard Test (described above) was carried out 15 minutes after printing. The curl after laser printing may be caused by the distortion (film shrinkage) of the facestock in combination of the moisture evaporation, which may cause the liner to shrink and the laminate to curl. The curling makes continuous sheet printing difficult, if not impossible.

Printer jam test: This test observes if, when the printer is jammed with a label, the label sticks to the fuser roll and damages the printer. Once jammed in the printer, the facestock may locally melt and the adhesive layer may ooze and stick to drum, causing web breaks.

An old laser printer was used to perform the jam test. The sample sheet was fed in the printer and then the printer was manually stopped while the sample sheet was passing through the fuser roll. After certain dwelling time (typically 20 s), the sheet was pulled out and inspected. The function of the fuser roll is to melt the solid toner particles into the film surface and its temperature can reach 180° C. The label was examined to determine that it was still a continuous sheet with no stringing when sheet was pulled out.

Labels with polyolefin (PP/PE) tend to distort during laser printing due to their low melting temperature. If the label is jammed in the printer and stays in contact with fuser roll for extended period of time, it can melt and stick to the fuser roll and damage to the printer. This is especially problematic with BS5609-certified printers that typically run at higher temperatures.

### Antistatic Testing

Samples in the form of sheets (8.5″×11″; 21.6×27.9 cm) were evaluated to determine if any had static prior to printing. A LEXMARK C792e color printer (commercially available from Lexmark International Inc., located in Kentucky, USA) was used for testing. Sample sheets were evaluated for jamming at the fuser area. Sample sheets were left in the fuser for two minutes after jam occurred (if any) to evaluate product melting.

In order to dissipate the static charge of the sample sheets, it is necessary to increase the conductivity or reduce the resistivity of the label. The surface resistance of both the facestock and liner were measured using a Trek 152-1 Resistance Meter (commercially available from Trek, Inc., located in New York, USA). It was desirable to have both face and liner resistance from 1E8 to 1E13 ohms, preferably, 1E8 to 1E12 ohms, more preferably from 1E9 to 1E10 ohms. It should be noted that if the facestock resistance is too low, a good laser printing may not be achieved. Also, high resistance may cause high static charge during sheeting, making it is not easy to stack together.

Opacity: The testing was completed in accordance with TAPPI standard T-425 (2016).

### Stress Relaxation Testing

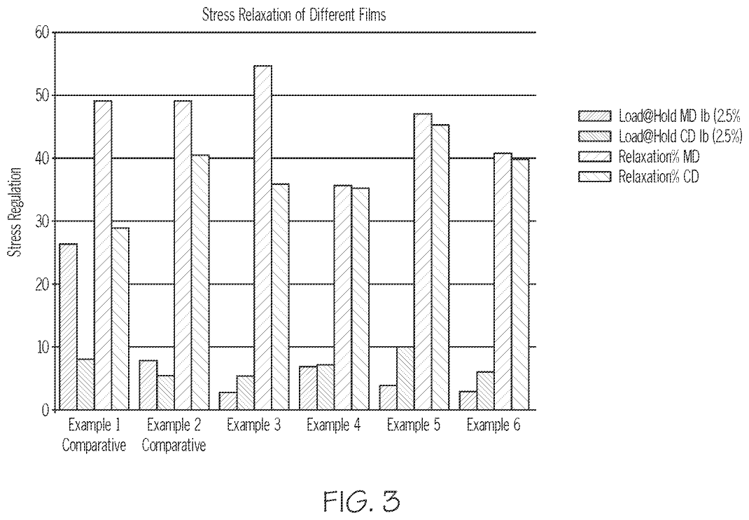

This test determined how much percentage the film stress relaxes after stretching and hold, where the higher the percentage of stress relaxation, the more flexible the film is. A pass was a stress relaxation of at least 35% in both MD and CD direction. Test results are shown in FIG. 3. Also measured was the load (lb/in) (N/m) at hold, where the lower the load at hold, the easier it was to stretch the film. A pass was a load at hold of less than 10 lb/in (1750 N/m) in both MD/CD directions. Accordingly, the test measured the flexibility or conformability of the film.

Stress Relaxation Test method: An Instron Tensile Tester (commercially available from Instron Corporation, located in Massachusetts, USA) was used to measure a sample 10″ gap 1″ wide (25.4×2.54 cm). The samples were stretched at 4 inch (10.2 cm) per minute crosshead speed for ¼″ (0.635 cm) or 2.5%. The initial load (lb/in; N/m) was measured. The samples were held for 12 minutes and then the load was measured again (residual stress lb/in; N/m) at the same strain. The stress relaxation was calculated as the percentage load loss after 12 minutes.

Abbreviations used in the application:
PP polypropylene
PE polyethylene
MD machine direction
CD cross direction
gsm grams/square meter
RH relative humidity
C1S coated on one side

The results are shown in the following table:

| | Example 1 | Example 2 | | | | |
|---|---|---|---|---|---|---|
| | Comparative | Comparative | Example 3 | Example 4 | Example 5 | Example 6 |
| Topcoat | Acrylic | Acrylic | Acrylic | Acrylic | Acrylic | Acrylic |
| Facestock | 100 μm MDO | 80 μm blown PP | 80 μm blown | 100 μm blown | 100 μm | 100 μm |
| Layer | PP/PE film | | and MD | and MD | biaxially | biaxially |
| | Transcode | | oriented PP | oriented PP | oriented PP | oriented PP |
| | Drumlabel | | (with minor PE) | (with minor PE) | (with minor PE) | (with minor PE) |
| | | | film with two | film with two | film with two | film with two |
| | | | non-woven | non-woven | non-woven | non-woven |
| | | | layers | layers | layers | layers |
| Adhesive | Acrylic | Acrylic | Acrylic | Acrylic | Acrylic | Acrylic |
| Layer | emulsion 1 | emulsion 1 | emulsion 1 | emulsion 1 | emulsion 1 | emulsion 2 |
| Release Layer | polycoated | polycoated kraft | polycoated | polycoated kraft | polycoated | polycoated |
| | kraft paper | paper | kraft paper | paper | kraft paper | kraft paper |
| | (siliconized) | (siliconized) | (siliconized) | (siliconized) | (siliconized) | (siliconized) |
| Print Key/ | 2/fail | 3/pass | 4/pass | 4/pass | 4/pass | not tested |
| Anchorage | (some red ink | (some ink | | | | |
| | transfer) | transfer) | | | | |
| Abrasion | 1/fail | 1/fail | 4/pass | 4/pass | 4/pass | — |
| Resistance | | | | | | |
| Color | 4/pass | — | 4/pass | 4/pass | 4/pass | — |
| Fastness | | | | | | |
| (after | | | | | | |
| artificial | | | | | | |
| accelerated | | | | | | |
| weathering) | | | | | | |
| Curl | Flat | Flat | Flat | Flat | Flat | — |
| (72° F./50% | | | | | | |
| relative | | | | | | |
| humidity) | | | | | | |
| Stress | MD: 49.2 | MD: 49.4 | MD: 54.8 | MD: 35.7 | MD: 47.1 | MD: 40.8 |
| relaxation % | CD: 29.1 | CD: 40.8 | CD: 36.0 | CD: 35.6 | CD: 45.6 | CD: 40.1 |
| Stress Load at | MD: 26.4 lb/in | MD: 7.8 lb/in | MD: 2.7 lb/in | MD: 6.8 lb/in | MD: 3.2 lb/in | MD: 2.8 lb/in |
| hold lb/in | (4620 N/m) | (1370 N/m) | (470 N/m) | (1190 N/m) | (560 N/m) | (490 N/m) |
| (N/m) | CD: 8.0 lb/in | CD: 5.5 lb/in | CD: 5.4 lb/in | CD: 7.1 lb/in | CD: 10.2 lb/in | CD: 5.9 lb/in |
| | (1400 N/m) | (960 N/m) | (950 N/m) | (1240 N/m) | (1790 N/m) | (1030 N/m) |
| Opacity | 87% | 91% | >95% | >95% | >95% | >95% |
| Laser Printing | Fair handling; | Somewhat | Fair/good | Very good | Very good | — |
| (Handling | ok to fan; even | difficult | handling after | stacking and | stacking and | |
| including | stacking in | handling; severe | printing; good | handling after | handling after | |
| static; layflat | output bin; did | diagonal curl | stacking in | printing; only | printing; only | |
| after laser | not pass layflat | after printing; | output binds; | slight static; able | slight static; | |
| printing and | after laser | some jamming - | some static | to fan for double | there was no | |
| jamming) | printing; no | some sheets | after printing; | feed | lift in the stack | |
| | jamming | folded back to | able to fan for | observation; | after 15 | |
| | | exit area causing | double feed | curled over time | minutes. | |
| | | jams; static after | observation; | | | |
| | | printing. | passed layflat | | | |
| | | | after laser | | | |
| | | | printing; no | | | |
| | | | jamming | | | |

When ranges are used herein for physical properties, such as molecular weight, or chemical properties, such as chemical formulae, all combinations, and sub-combinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A label construction, comprising:
a facestock with a first surface and a second surface;
wherein the facestock comprises a laminate comprising:
at least one film layer comprising:
a first polymer having a melting point;
wherein the first polymer is selected from the group consisting of a polypropylene polymer, polypropylene copolymer, and a combination thereof; and
at least one of an opacifying agent and a cavitating agent; and
at least one non-woven layer comprising a second polymer;
wherein the second polymer has a melting point at least 5° C. greater than the melting point of the first polymer;
a topcoat applied to at least a portion of the first surface of the facestock; and
an adhesive layer with a first surface and a second surface;
wherein the first surface of the adhesive layer is applied to at least a portion of the second surface of the facestock.

2. The label construction of claim 1, further comprising:
a release liner layer applied to at least a portion of the second surface of the adhesive layer.

3. The label construction of claim 2,
wherein the release liner layer comprises one of a polycoated kraft paper (PCK) or polyethylene terephthalate (PET) film.

4. The label construction of claim 1,
wherein the laminate comprises:
one film layer; and
two non-woven layers;
wherein the film layer is between the two non-woven layers.

5. The label construction of claim 1,
wherein at least one of the film layer and the laminate is microporous.

6. The label construction of claim 1,
wherein the film layer is oriented in a machine direction.

7. The label construction of claim 1,
wherein the laminate is oriented in a machine direction.

8. The label construction of claim 1,
wherein the film layer is biaxially oriented.

9. The label construction of claim 1,
wherein the laminate is biaxially oriented.

10. The label construction of claim 1,
wherein the film layer is a blown film that is additionally stretched in the machine direction.

11. The label construction of claim 1,
wherein the facestock has a total thickness of from 50 μm to 150 μm.

12. (canceled)

13. The label construction of claim 1,
wherein the first polymer is a polymer selected from the group consisting of a polypropylene homopolymer, a polypropylene-polyethylene copolymer, and combinations thereof.

14. The label construction of claim 1,
wherein the second polymer is a polymer selected from the group consisting of a polypropylene homopolymer, a polypropylene copolymer, and combinations thereof.

15. The label construction of claim 1,
wherein the second polymer is a polymer selected from the group consisting of a polypropylene homopolymer, and a blend of a polypropylene (co)polymer and a polyethylene (co)polymer, and combinations thereof.

16. (canceled)

17. The label construction of claim 1,
wherein the opacifying agent is selected from the group consisting of titanium dioxide, calcium carbonate, talc, and combinations thereof.

18. The label construction of claim 1,
wherein the cavitating agent is at least one of an organic polymer and an inorganic material.

19. The label construction of claim 18,
wherein the organic polymer is selected from the group consisting of a polyamide, polyester, acrylic resin, and combinations thereof.

20. The label construction of claim 18,
wherein the organic polymer is selected from the group consisting of a cyclic olefin polymer, cyclic olefin copolymer, ethylene norbornene copolymer, and combinations thereof.

21. The label construction of claim 18,
wherein the inorganic material is selected from the group consisting of a glass, metal, ceramic, silica, calcium carbonate (CaCO3), clay, talc and combinations thereof.

22. The label construction of claim 1,
wherein the coatweight level of the topcoat is less than 10 gsm.

23. The label construction of claim 1,
wherein the topcoat comprises at least one of an acrylic polymer and a urethane acrylic polymer.

24. (canceled)

25. The label construction of claim 1,
wherein the adhesive layer comprises an acrylic polymer.

26. The label construction of claim 25,
wherein the acrylic polymer is produced by one of emulsion polymerization, solvent polymerization, and polymerization by UV exposure.

27. A storage drum, comprising:
a container;
wherein the container is formed from a material selected from the group consisting of plastic, metal, cellulose fiber, and combinations thereof; and
a label comprising:
the label construction of claim 1; and
a laser-printed indicia applied to the topcoat.
